(19) United States
(12) Patent Application Publication
(10) Pub. No.: US 2019/0004788 A1
(43) Pub. Date: Jan. 3, 2019

(54) SECURE MICROCODE UPDATE

(71) Applicant: Intel Corporation, Santa Clara, CA (US)

(72) Inventors: Marcio Rogerio Juliato, Portland, OR (US); Jeffrey Gordon Wiedemeier, Austin, TX (US); Rohit Rajasekharan, Austin, TX (US)

(21) Appl. No.: 15/640,158

(22) Filed: Jun. 30, 2017

(51) Int. Cl. G06F 9/445; G06F 21/57; G06F 9/24

(52) U.S. Cl. CPC G06F 8/665; G06F 9/24; G06F 21/572

(57) ABSTRACT

Various systems and methods for secure microcode updates are described herein. An integrated circuit for secure microcode updates, including a hash circuit to determine a hash of a current patch content, a memory controller to obtain, from an on-die non-volatile memory device, a copy of a previously-determined hash of a previous patch content, and a patch loader to validate the current patch content by comparing the hash of the current patch content with the hash of the previous patch content and apply the current patch content when the current patch content is validated.

### TECHNICAL FIELD

Embodiments described herein generally relate to processor microarchitecture, and in particular, to systems and methods for secure microcode updates.

### BACKGROUND

Processor microcode is programmable code embedded in the processor that gets executed, for example, to configure the processor. Microcode may include various microinstructions, which are instructions that control the processor at a fundamental level of hardware. The microcode may be patched by system firmware or operating systems. Microcode patches may be used to repair bugs or provide enhancements to existing processor microcode.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 is a diagram illustrating an exemplary hardware and software architecture microarchitecture of a computing device, in which various interfaces between hardware components and software components are shown, according to an embodiment;

FIG. 2 is a block diagram illustrating processing devices, according to an embodiment;

FIG. 3 is a block diagram illustrating example components of CPU, according to an embodiment;

FIG. 4 is a block diagram illustrating a die microarchitecture, according to an embodiment;

FIG. 5 is a block diagram illustrating a die microarchitecture, according to an embodiment;

FIG. 6 is a flowchart illustrating execution flow for patch loading, according to an embodiment;

FIG. 7 is a flowchart illustrating a method of performing secure microcode updates, according to an embodiment; and

FIG. 8 is a block diagram illustrating an example machine upon which any one or more of the techniques (e.g., methodologies) discussed herein may perform, according to an embodiment.

### DETAILED DESCRIPTION

In the following description, for purposes of explanation, numerous specific details are set forth in order to provide a thorough understanding of some example embodiments. It will be evident, however, to one skilled in the art that the present disclosure may be practiced without these specific details.

Many modern processors provide a mechanism to update microcode. Microcode updates provide the capability to correct errors by loading a data block in the processor (called the microcode update). Using microcode updates to correct errors avoids costly product recalls and chip redesigns. Microcode updates are protected by encryption and authentication mechanisms to ensure both the confidentiality and integrity of the update contents.

One traditional cryptographic flow decrypts the patch (e.g., microcode update) to obtain a plaintext of the microcode, checks its signature, and, if the signature matches with the expected value, applies the plaintext of the microcode to the central processing unit (CPU). The microcode update is volatile, meaning that the update is lost and needs to be reapplied every time the power on the CPU is cycled. On each re-application of the microcode update, the entire update process is triggered, which may include decryption and authentication processes. The full decryption and authentication of the microcode update is a time-consuming process. As the cryptographic algorithms used to ensure the confidentiality and integrity of the update advance, it is becoming even more time consuming, even as processors become more capable. The entire update process may be non-trivial, causing slow patch loads with strong encryption, or use of a weaker encryption in an attempt to decrease patch load times. What is needed is a mechanism to avoid the expensive computation of signature verification during patch loads.

The present disclosure describes ways to improve the patch load efficiency by substituting a traditional hash and signature verification method with a plaintext of the patch with multiple hashes, in one type of embodiment, and with just a single hash stored, in another type of embodiment. To implement the simpler flow, an on-die non-volatile storage device (e.g., non-volatile random access memory (NVRAM)) is used to store patch data. On-die NVRAM is preferable to on-package NVRAM in order to avoid transmitting sensitive information over a memory bus between the memory and the CPU. An advanced attacker may open the package and sniff the bus between the dies. Protecting microcode in the on-package NVRAM may require similar encryption/decryption and signature verification techniques as to those being used conventionally, and consequently may result in a similar patch and load times.

The proposed approach is implemented using on-die NVRAM in a microcode patch process. Utilizing a minimal amount of NVRAM on-die balances the increase in die size to accommodate additional memory circuitry with increased verification speeds and faster patch times. By adding a small amount of non-volatile memory (NVM) into the CPU, considerable speed up may be gained in the decryption, hash, and signature verification of the patch.

This disclosure includes at least two options to satisfy different constraints in terms of time and area footprint. The time efficient approach trades off a larger die area to use for NVM in order to achieve even higher patching speed. The time efficient approach uses NVM at least the size of an expected patch in plaintext plus additional bits to store the hash of the plaintext patch, in an area footprint approach, the NVM size is minimized by only storing the hash in NVM. This is arguably much smaller than implementing a traditional set of algorithms in silicon to perform cryptographic functions (e.g., AES, SHA, RSA, ECDSA, etc.). Embodiments may use secure bit widths of 128 or 256 bit hashes, or any other size convenient to the target application.

Restated, in the first approach, the proposed mechanism avoids the execution of two of the heaviest mechanisms (namely decryption and signature verification) in the current patch load mechanism. In other words, it substitutes the sequence decryption/hash/signature verification, with a single hash computation. The size of the on-die NVM has to be as large as the maximum expected size of the patch plaintext, plus the number of bits necessary to hold the hash of the external patch (patch to be loaded). Though the maximum patch size is implementation dependent, the usual size of the patch for a modern processor, such as the Quark CPU, for example, is likely to be under 10 kilobytes. In an optional embodiment, additional bits are used to store the hash of the internal patch (patch stored in NVM) in addition to the hash of the external patch.

The main disadvantage of this method is that it requires a larger NVM to be placed inside the CPU. Since the NVM holds the plaintext of the patch binary, it is not secure to have the NVM off-die. Placing the NVM off-die would allow a more advanced attacker to open the package and snoop the interconnecting bus between the CPU and the off-die NVM, which would end up leaking the patch plaintext.

The second approach proposed in this disclosure (e.g., size efficient approach) requires less on-die implementation area compared to the first approach, at the cost of not being as fast during patch time. The second approach introduces a mechanism that avoids the execution of the heaviest mechanism (namely signature verification) in the current patch load mechanism. In other words, it replaces the costly signature verification with the computation of a hash. The required amount of on-die NVM to achieve that is the size of a hash (in an embodiment 256 bits, in another embodiment 128 bits, etc.).

Compared to the first approach, the second approach provides the benefit of not requiring a large NVM to be placed on-die, which may be costly to produce. Its main drawback is that it does not avoid the patch decryption operation in subsequent loads. However, compared to the traditional patch load mechanism, it avoids the computation of RSA in the signature verification, while minimizing the amount of on-die NVM.

While both approaches utilize the full patch load mechanism and run the full set of algorithms once for a given version of the patch, the subsequent loads of that version of the patch run much more efficiently as they avoid the costly computation of signature verification. Because microcode patches are not expected to be released often, these methods significantly reduce patching time in the vast majority of system boot-ups.

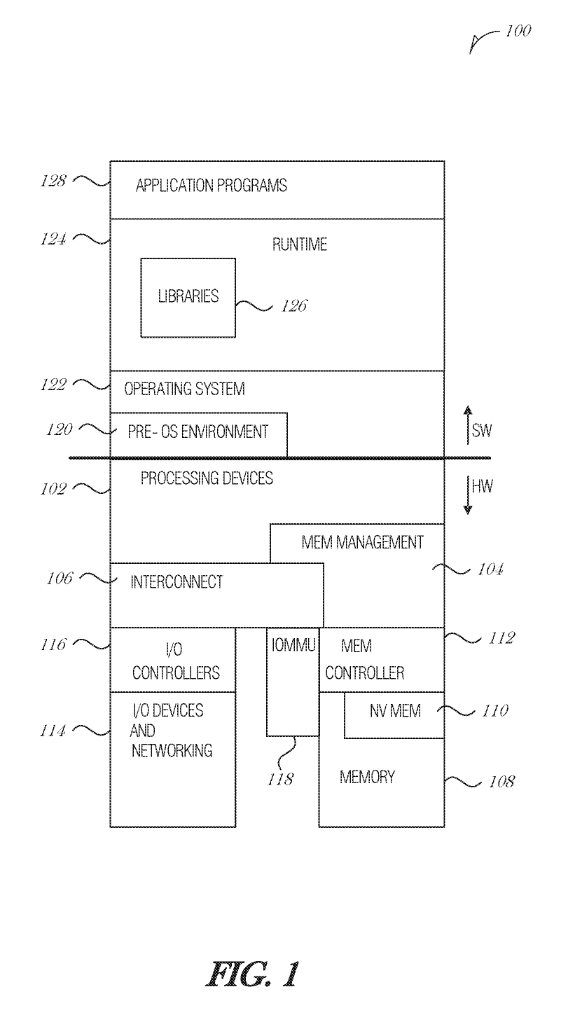

FIG. 1 is a diagram illustrating an exemplary hardware and software architecture microarchitecture 100 of a computing device, in which various interfaces between hardware components and software components are shown, according to an embodiment. As indicated by HW, hardware components are represented below the divider line, whereas software components, denoted by SW, reside above the divider line. On the hardware side, processing devices 102 (which may include one or more microprocessors, digital signal processors, etc., each having one or more processor cores, are interfaced with memory management device 104 and system interconnect 106. Memory management device 104 provides mappings between virtual memory used by processes being executed, and the physical memory 108. Memory management device 104 may be an integral part of a central processing unit which also includes the processing devices 102.

Interconnect 106 includes a backplane such as memory, data, and control lines, as well as the interface with input/output devices, e.g., PCI, USB, etc. Memory 108 (e.g., dynamic random access memory DRAM) and non-volatile memory 110 such as flash memory (e.g., electrically-erasable read-only memory—EEPROM, NAND Hash, NOR Flash, etc.) are interfaced with memory management device 104 and interconnect 106 via memory controller 112. This architecture microarchitecture 100 may support direct memory access (DMA) by peripherals in some embodiments, I/O devices, including video and audio adapters, non-volatile storage, external peripheral links such as USB, Bluetooth, etc., as well as network interface devices such as those communicating via Wi-Fi or LTE-family interfaces, are collectively represented as I/O devices and networking 114, which interface with interconnect 106 via corresponding I/O controllers 116.

In a related embodiment, input/output memory management unit IOMMU 118 supports secure direct memory access (DMA) by peripherals. IOMMU 118 may provide memory protection by meditating access to memory 108 from I/O device 114. IOMMU 118 may also provide DMA memory, protection in virtualized environments, where it allows certain hardware resources to be assigned to certain guest VMs running on the system, and enforces isolation between other VMs and peripherals not assigned to them.

On the software side, a pre-operating system (pre-OS) environment 120, which is executed at initial system start-up and is responsible for initiating the boot-up of the operating system. One traditional example of pre-OS environment 120 is a system basic input/output system (BIOS). In present-day systems, a unified extensible firmware interface (UEFI) may be implemented. Pre-OS environment 120, is responsible for initiating the launching of the operating system, but also provides an execution environment for embedded applications.

Operating system (OS) 122 provides a kernel that controls the hardware devices, manages memory access for programs in memory, coordinates tasks and facilitates multi-tasking, organizes data to be stored, assigns memory space and other resources, loads program binary code into memory, initiates execution of the application program which then interacts with the user and with hardware devices, and detects and responds to various defined interrupts. Also, operating system 122 provides device drivers, and a variety of common services such as those that facilitate interfacing with peripherals and networking, that provide abstraction for application programs so that the applications do not need to be responsible for handling the details of such common operations. Operating system 122 additionally provides a graphical user interface (GUI) that facilitates interaction with the user via peripheral devices such as a monitor, keyboard, mouse, microphone, video camera, touchscreen, and the like.

Runtime system 124 implements portions of an execution model, including such operations as putting parameters onto the stack before a function call, the behavior of disk input/output (I/O), and parallel execution-related behaviors. Runtime system 124 may also perform support services such as type checking, debugging, or code generation and optimization.

Libraries 126 include collections of program functions that provide further abstraction for application programs. These include shared libraries, dynamic linked libraries (DLLs), for example. Libraries 126 may be integral to the operating system 122, runtime system 124, or may be added-on features, or even remotely-hosted. Libraries 126 define an application program interface (API) through which a variety of function calls may be made by application programs 128 to invoke the services provided by the operating system 122. Application programs 128 are those programs that perform useful tasks for users, beyond the tasks performed by lower-level system programs that coordinate the basis operability of the computing device itself.

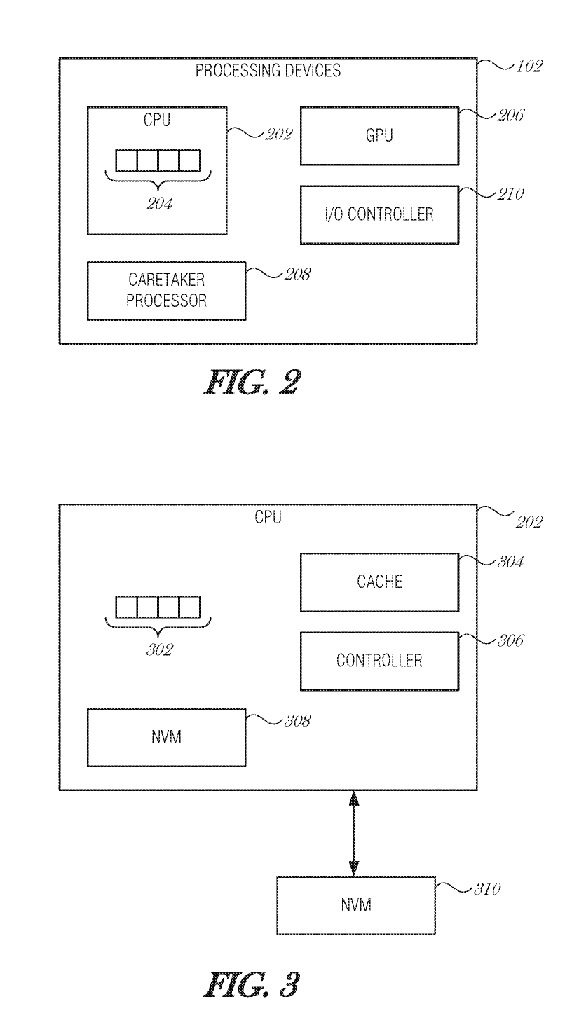

FIG. 2 is a block diagram illustrating processing devices 102, according to an embodiment. In an embodiment, two or more of processing devices 102 depicted are formed on a common semiconductor substrate. CPU 202 may contain one or more processing cores 204, each of which has one or more arithmetic logic units (ALU), instruction fetch units, instruction decode units, control units, registers, data stack pointers, program counters, and other components according to the particular architecture of the processor 202. As an illustrative example, CPU 202 may be an x86-type of processor. Processing devices 102 may also include a graphics processing unit (GPU) 206. In these embodiments, GPU 206 may be a specialized co-processor that offloads certain computationally-intensive operations, particularly those associated with graphics rendering, from CPU 202. Notably, CPU 202 and GPU 206 generally work collaboratively, sharing access to memory resources, I/O channels, etc.

Processing devices 102 may also include caretaker processor 208 in some embodiments. Caretaker processor 208 generally does not participate in the processing work to carry out software code as CPU 202 and CPU 206 do. In some embodiments, caretaker processor 208 does not share memory space with CPU 202 and GPU 206, and is therefore not arranged to execute operating system or application programs. Instead, caretaker processor 208 may execute dedicated firmware that supports the technical workings of CPU 202, GPU 206, and other components of the computer system. In some embodiments, caretaker processor 208 is implemented as a microcontroller device, which may be physically present on the same integrated circuit die as CPU 202, or may be present on a distinct integrated circuit die. Caretaker processor 208 may also include a dedicated set of I/O facilities to enable it to communicate with external entities. In an embodiment, caretaker processor 208 is implemented using a manageability engine (ME) or platform security processor (PSP). In another embodiment, caretaker processor 208 may take the form of a power control unit (PCU) in some system architectures.

Input/output (I/O) controller 210 coordinates information flow between the various processing devices 202, 206, 208, as well as with external circuitry, such as a system interconnect or main memory (e.g., DRAM).

FIG. 3 is a block diagram illustrating example components of CPU 202, according to an embodiment. As depicted, CPU 202 includes one or more cores 302, cache 304, and CPU controller 306, which coordinates interoperation and tasking of the core(s) 302, as well as providing an interface to facilitate data flow between the various internal components of CPU 202, and with external components such as a memory bus or system interconnect. In an embodiment, all of the example components of CPU 202 are formed on a common semiconductor substrate.

CPU 202 includes non-volatile memory 308 (e.g., flash, EEPROM, etc.) for storing certain portions of foundational code, such as initialization instructions, and microcode. Also, CPU 202 may be interfaced with an external (e.g., formed on a separate IC) non-volatile memory device 310 that stores foundational code that is launched by the initialization instructions, such as system BIOS or UEFI code.

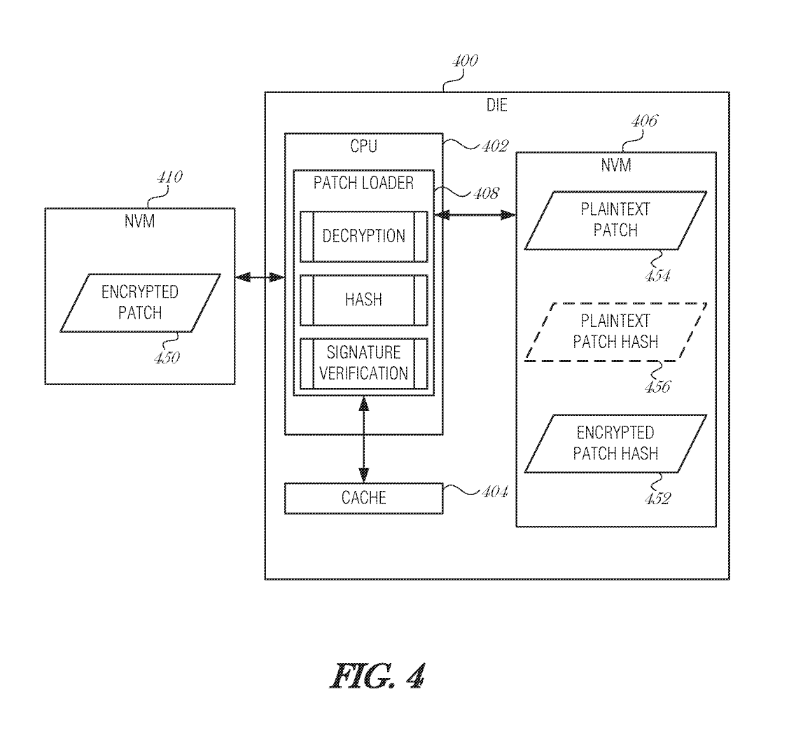

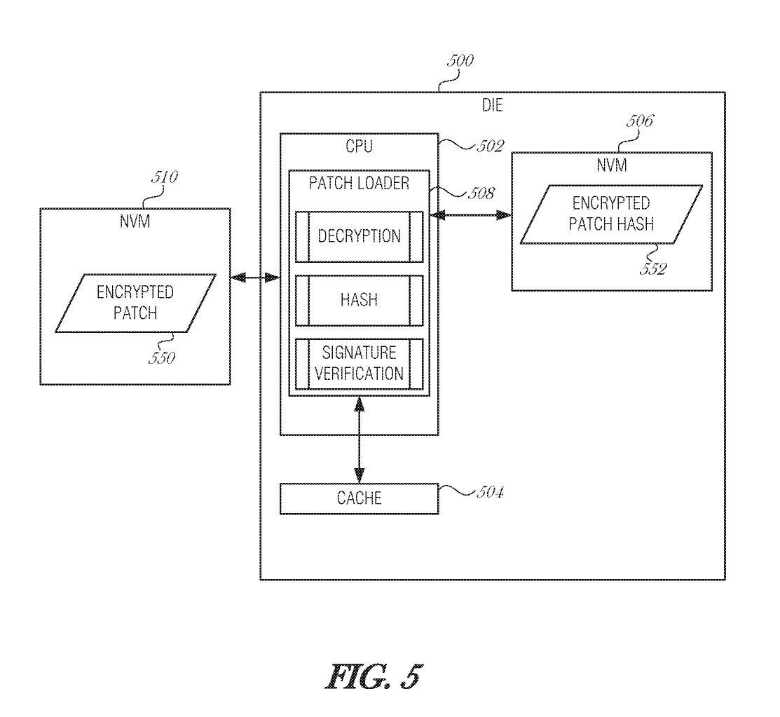

FIG. 4 is a block diagram illustrating a die microarchitecture 400, according to an embodiment. The die microarchitecture 400 includes CPU 402, cache 404, and non-volatile memory (NVM) 406. CPU 402 includes patch loader 408, which provides various cryptographic mechanisms, such as a decryption process, a hash process, and a signature verification process. Patch loader 408 is communicatively coupled to NVM 406, such by way of a bus, interconnect, or other mechanism. Additionally, patch loader 408 is communicatively coupled to cache 404 to store intermediate forms of data, such as unencrypted patches, for example patch loader 408 may be coupled to cache 404 using similar interconnects, busses, interlinks, or the like, in a similar manner that patch loader 408 is coupled to NVM 406.

Patch loader 408 is also coupled to external NVM 410, which is external with respect to the die architecture 400. NVM 410 may be of any of a variety of non-volatile memory, including but not limited to flash memory, EEPROM, or the like.

In operation, during an initial load (e.g., the first time that a given patch load is triggered), a full run of the loader mechanism is executed. In particular, encrypted patch 450 is loaded from external NVM 410 into cache 404 where it is processed with cryptographic mechanisms. For instance, a hash of the encrypted patch 450 may be calculated (e.g., encrypted patch hash 452), the encrypted hash may be decrypted, and other operations may be performed. In an embodiment, the decrypted patch (e.g., plaintext patch 454) may be processed, for example, by calculating a hash of the plaintext patch 456. A patch signature may be verified before allowing the patch to load. A full patch load is triggered when any field of encrypted patch 450 changes, such as a version change or an integrity check failure). As long as encrypted patch 450 is kept the same, the optimized subsequent patch load operation (described below) is used instead of an initial patch load operation.

Subsequent patch loads are performed by checking the patch version. If the patch version has changed, then the initial (e.g., full) load is performed. If the patch version is the same as was used on a previous CPU power cycle, then a hash of encrypted patch 450 is calculated and compared to the encrypted patch hash 452 stored in NVM 406. If the hash digest matches the one stored on the on-die NVM 406, then the integrity of the patch has been maintained. Consequently, the patch loader 408 may use the stored plaintext patch 454 from NVM 406, instead of decrypting encrypted patch 450 from external NVM 410. In this manner, patch loader 408 avoids the costly decryption operation. Patch loader 408 may also avoid other authentication and integrity checks that are typically performed on initial loads, such as a signature verification. If the hashes do not match, then there is an integrity check fault and a full initial load is triggered.

Cryptographically speaking, the pre-image resistance property of the hash function guarantees that the attacker cannot benefit from knowing the patch hash. Because of the way a one-way hash works, it is infeasible or impossible for an attacker to derive a new patch that has the same hash as the original patch, and pass it off as being valid. Hence, it is infeasible to try different patches with the hope of having one of them matching the hash stored inside the CPU.

The second pre-image resistance guarantees that even if the attacker has the patch and its associated hash, it is infeasible to come up with another patch that would have the same hash as the original patch. Thus, the attacker does not benefit from having access to the patches and their associated hashes to mount an attack.

The collision resistance property also makes it impossible for an attacker to find two patches that would result in the same hash. Thus, even if an attacker is able to collect a set of valid patches, the attacker could not use that set to find another patch that would match one of the known hashes.

An additional level of security may be achieved by calculating a plaintext patch hash on a plaintext version of encrypted patch 450, and comparing this intermediate patch hash with the stored plaintext patch hash 456 from NVM 406. Comparing a second hash provides additional protection towards the integrity of plaintext patch 454 stored in NVM 406. For instance, if multiple bits flip, internal memory controllers may not detect an error with NVM 406, and a faulty plaintext patch 454 may be applied. Bit flips in plaintext patch 454 may be the result of a purposeful attack (e.g., an attacker flipping bits using directed radiation), or may be the result of an aging or faulty device. In any case, having a cryptographic hash computed over the plaintext patch and comparing the result with a previously-stored version of the plaintext patch hash would detect a fault. If the plaintext patch is corrupted, then a full patch load may be initiated.

FIG. 5 is a block diagram illustrating a die microarchitecture 500, according to an embodiment. The die microarchitecture 500 includes CPU 502, cache 504, and non-volatile memory (NVM) 506. CPU 502 include patch loader 508, which provides various cryptographic mechanisms, such as a decryption process, a hash process, and a signature verification process. Patch loader 508 is communicatively coupled to NVM 506, such by way of a bus, interconnect, or other mechanism. Additionally, patch loader 508 is communicatively coupled to cache 504 to store intermediate forms of data, such as unencrypted patches, for example patch loader 508 may be coupled to cache 504 using similar interconnects, busses, interlinks, or the like, in a similar manner that patch loader 508 is coupled to NVM 506.

Patch loader 508 is also coupled to external NVM 510, which is external with respect to the die architecture 500. NVM 510 may be of any of a variety of non-volatile memory, including but not limited to flash memory, EEPROM, or the like.

Initial load operation is the same as the approach discussed in FIG. 4. For instance, a full run of the loader mechanism is executed. The encrypted patch 550 is loaded from external NVM 510 into cache 504 where it is processed with cryptographic mechanisms. Decryption, hashing, signature verification, and other operations may be performed during the initial load. In light of a successful patch load, a hash of the encrypted patch 550 is stored in on-die NVM 506 as encrypted patch hash 552. The encrypted patch hash 552 is used in subsequent loads to decrease load time.

By only storing the encrypted patch hash 552 in on-die NVM 506, the on-die NVM 506 may be smaller and the die size may be reduced in comparison to the first approach described in FIG. 4. The tradeoff is processing time, which increases in comparison to the first approach because the encrypted patch 550 has to be decrypted during any subsequent load.

The hash stored in NVM 506 is the hash of the entire encrypted patch 552, which is different from a hash that may be used in signature verification of a plaintext version of the patch. The hash of the encrypted patch 552 may be computed either during the process of loading the external patch into the cache 504 or afterwards, as long as it is computed before or during the decryption of the encrypted patch 552.

In subsequent patch loads, after encrypted patch 552 is brought into cache 504, the first operation performed is the check of the patch version. If the version changed, a full initial load is performed. If the patch version remains the same, what follows is the computation of the hash over the encrypted patch 552 (now located in the cache 504). If the computed hash digest matches the one stored on the on-die. NVM 506, it means that the integrity of the encrypted patch 550 has been maintained. Consequently, the initial load signature verification remains valid and the cryptographic mechanism execution may be securely, bypassed. Signature verification may be performed using a public-key cryptosystem, such as RSA or ECDSA, which is costly for the processor. If the computed hash does not match, then an initial load is triggered. The use of encrypted patch hash 552 provides the same types of cryptographic advantages as that provided in the first approach.

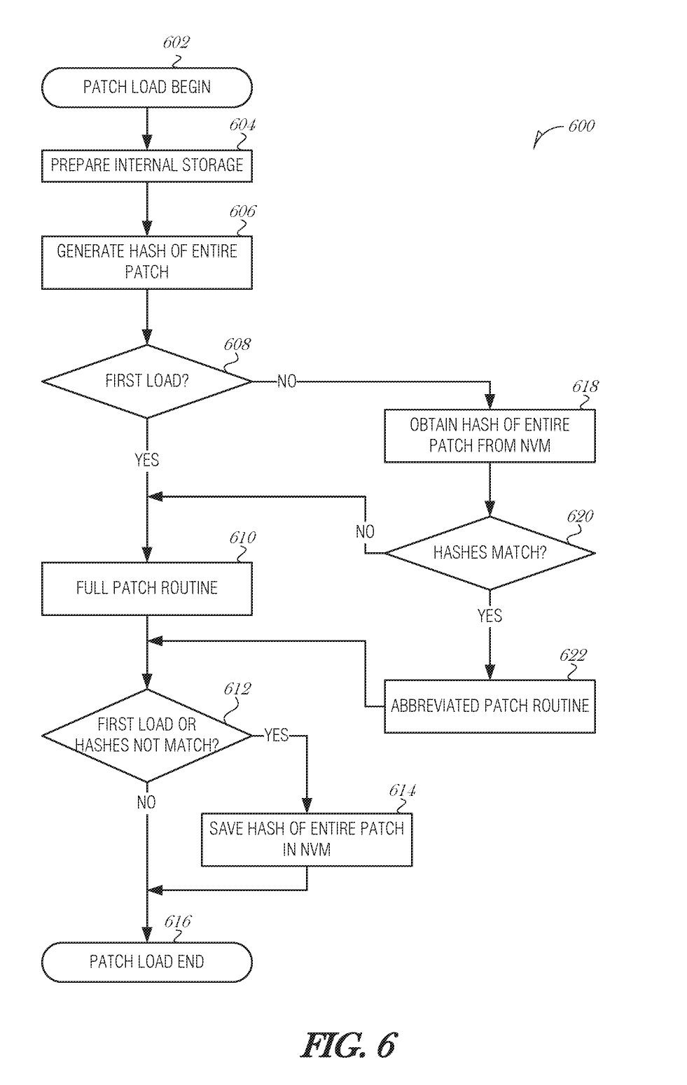

FIG. 6 is a flowchart illustrating execution flow for patch loading, according to an embodiment. The patch load process begins (operation 602) and internal storage is prepared (operation 604). Internal storage preparation may include setting up the cache for a patch loader routine and loading the externally-stored encrypted patch into cache.

The hash of the entire patch (e.g., encrypted patch) is generated at operation 606. If it is determined that this is the first time for this patch load (decision operation 608), then a full patch routine is executed (operation 610). The full patch routine may include various operations and cryptographic mechanisms, such as decrypting the entire patch, performing authentication routines, and integrity checks. If it is a first load of the patch (decision operation 612), then at operation 614, the hash of the entire encrypted patch is stored in NVM. The patch load process ends at 616.

If the determination at decision operation 608 is that it is not a first load, then the hash of the entire patch is obtained from NVM (operation 618). The hash generated at operation 606 is compared to the hash obtained from NVM, and if the hashes do not match (as determined at decision operation 620), then flow continues to the full patch routine 610. When the hashes do not match, it indicates that the patch being loaded is different than the one that was previously loaded.

If the hashes match, then an abbreviated patch routine may be used (operation 622). As discussed above, the abbreviated patch routine may omit certain portions of the full patch routine, such as decryption when the plaintext patch is stored in NVM, or signature verification, or other portions of the full patch routine.

In an embodiment, the abbreviated patch routine relies on a previously-stored encrypted patch hash obtained from NVM to confirm that the version being loaded is authentic and valid. In view of this confirmation operation, the abbreviated patch routine may obtain a plaintext patch from NVM and apply it to the CPU. In an alternative embodiment, the plaintext patch from NVM may be validated using a hash check. A hash of an unencrypted copy of the entire patch (e.g., the encrypted patch stored in cache) may be obtained and compared to a copy of the plaintext hash that was previously generated and stored in NVM. If the two hashes match, then the plaintext patch is validated and may be applied with high confidence that it is unaltered.

In another embodiment, the abbreviated patch does not use a plaintext patch that was stored in NVM. Instead, if the previously-stored encrypted patch hash obtained from NVM matches the entire patch hash computed at operation 606, then an unencrypted copy of the entire patch is obtained and applied. The encrypted patch is decrypted and may applied to the CPU. Because the hashes matched, the patch loader may operate with high confidence that the patch is valid, and may skip any signature verification operations that would normally be used in the full patch routine 610.

After the abbreviated patch routine concludes, flow continues to decision operation 612 to determine whether to save the hash of the entire patch in NVM (operation 614). The patch load process then concludes (operation 616).

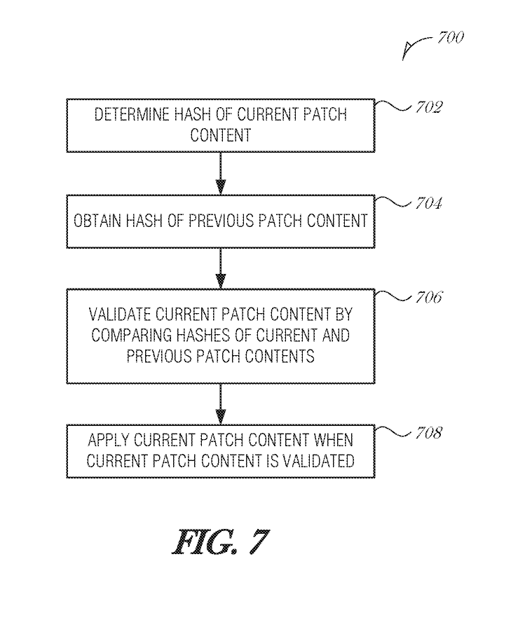

FIG. 7 is a flowchart illustrating a method 700 of performing secure microcode updates, according to an embodiment. At 702, a hash of a current patch content is determined at an integrated circuit. In an embodiment, the integrated circuit is incorporated into a central processing unit. It is understood that the integrated circuit may be implemented in various forms, including a hardware component, programmable logic (e.g., an FPGA or ASIC), or the like. In an embodiment, the current patch content comprises an encrypted patch.

At 704, a copy of a previously-determined hash of a previous patch content is obtained from an on-die non-volatile memory device. In an embodiment, the on-die non-volatile memory device comprises a flash memory device. In a related embodiment, the on-die non-volatile memory device comprises an erasable programmable read-only memory device.

At 706, the current patch content is validated by comparing the hash of the current patch content with the hash of the previous patch content. In an embodiment, the hash of the previous patch content was obtained during a previous patch load operation of the current patch content.

At 708, the current patch content is applied when the current patch content is validated. The current patch content may be applied by restoring a stored version of the current patch content, such as from a plaintext copy that was stored in NVM. Thus, in an embodiment, applying the current patch content comprises obtaining plaintext patch content of the current patch content from the on-die non-volatile memory and using the plaintext patch content to apply the patch. In a further embodiment, the method 700 includes validating the plaintext patch content before using it to the apply the patch. In a further embodiment, validating the plaintext patch content comprises obtaining a hash of plaintext of the current patch content and comparing the hash of the plaintext of the current patch content with a hash of a plaintext patch that was previously applied. In a further embodiment, the hash of the plaintext patch that was previously applied is stored in the on-die non-volatile memory.

Alternatively, the current patch content may be applied from the current patch content as received externally from the integrated circuit. Thus, in another embodiment, applying the current patch content comprises decrypting the current patch content to obtain a plaintext patch content and using the plaintext patch content to apply the patch.

Embodiments may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

A processor subsystem may be used to execute the instruction on the machine-readable medium. The processor subsystem may include one or more processors, each with one or more cores. Additionally, the processor subsystem may be disposed on one or more physical devices. The processor subsystem may include one or more specialized processors, such as a graphics processing unit (GPU), a digital signal processor (DSP), a field programmable gate array (FPGA), or a fixed function processor.

Examples, as described herein, may include, or may operate on, logic or a number of components, modules, or mechanisms. Modules may be hardware, software, or firmware communicatively coupled to one or more processors in order to carry out the operations described herein. Modules may be hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

Circuitry or circuits, as used in this document, may comprise, for example, singly or in any combination, hardwired circuitry, programmable circuitry such as computer processors comprising one or more individual instruction processing cores, state machine circuitry, and/or firmware that stores instructions executed by programmable circuitry. The circuits, circuitry, or modules may, collectively or individually, be embodied as circuitry that forms part of a larger system, for example, an integrated circuit (IC), system on-chip (SoC), desktop computers, laptop computers, tablet computers, servers, smart phones, etc.

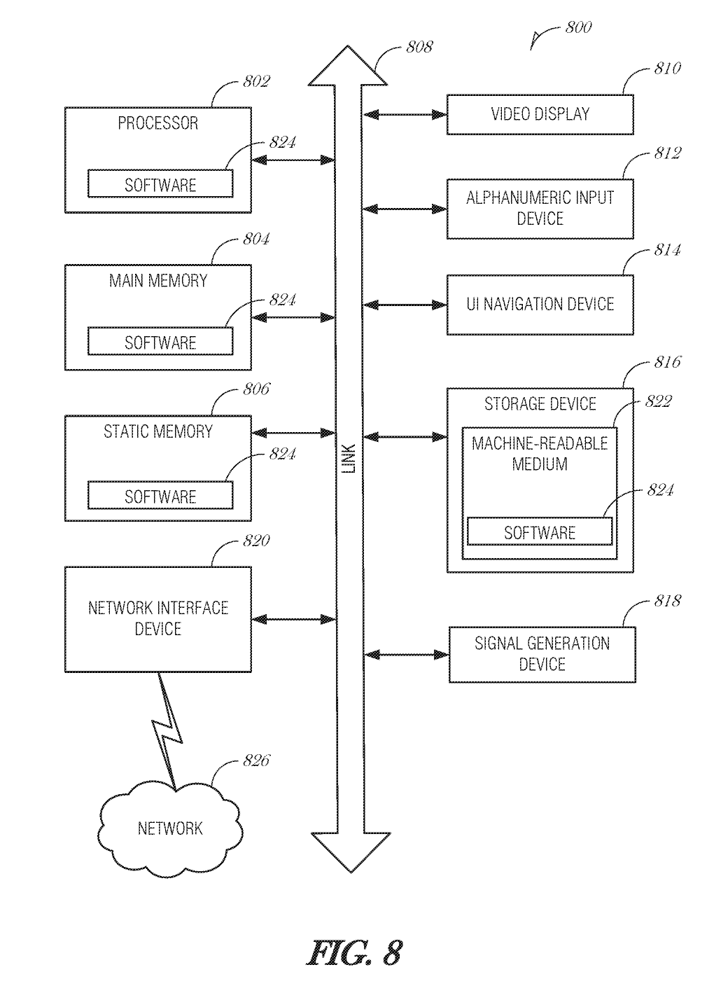

FIG. 8 is a block diagram illustrating a machine in the example form of a computer system 800, within which a set or sequence of instructions may be executed to cause the machine to perform any one of the methodologies discussed herein, according to an embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be a head-mounted display, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an alphanumeric input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, gyrometer, magnetometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Bluetooth, 3G, and 4G LTE/LTE-A, 5G, DSRC, or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### Additional Notes & Examples

Example 1 is an integrated circuit for secure microcode updates, the integrated circuit comprising: a hash circuit to determine a hash of a current patch content; a memory controller to obtain, from an on-die non-volatile memory device, a copy of a previously-determined hash of a previous patch content; a patch loader to: validate the current patch content by comparing the hash of the current patch content with the hash of the previous patch content; and apply the current patch content when the current patch content is validated.

In Example 2, the subject matter of Example 1 optionally includes wherein the integrated circuit is incorporated into a central processing unit.

In Example 3, the subject matter of any one or more of Examples 1-2 optionally include wherein the current patch content comprises an encrypted patch.

In Example 4, the subject matter of any one or more of Examples 1-3 optionally include wherein the on-die non-volatile memory device comprises a flash memory device.

In Example 5, the subject matter of any one or more of Examples 1-4 optionally include wherein the on-die non-volatile memory device comprises an erasable programmable read-only memory device.

In Example 6, the subject matter of any one or more of Examples 1-5 optionally include wherein the hash of the previous patch content was obtained during a previous patch load operation of the current patch content.

In Example 7, the subject matter of any one or more of Examples 1-6 optionally include wherein to apply the current patch content, the patch loader is to: obtain plaintext patch content of the current patch content from the on-die non-volatile memory; and use the plaintext patch content to apply the patch.

In Example 8, the subject matter of Example 7 optionally includes wherein the patch loader is to: validate the plaintext patch content before using it to the apply the patch.

In Example 9, the subject matter of Example 8 optionally includes wherein to validate the plaintext patch content, the patch loader is to: obtain a hash of plaintext of the current patch content; and compare the hash of the plaintext of the current patch content with a hash of a plaintext patch that was previously applied.

In Example 10, the subject matter of Example 9 optionally includes wherein the hash of the plaintext patch that was previously applied is stored in the on-die non-volatile memory.

In Example 11, the subject matter of any one or more of Examples 1-10 optionally include wherein to apply the current patch content, the patch loader is to: decrypt the current patch content to obtain a plaintext patch content; and use the plaintext patch content to apply the patch.

Example 12 is a method of secure microcode updates, the method comprising: determining, at an integrated circuit, a hash of a current patch content; obtaining, from an on-die non-volatile memory device, a copy of a previously-determined hash of a previous patch content; validating the current patch content by comparing the hash of the current patch content with the hash of the previous patch content; and applying the current patch content when the current patch content is validated.

In Example 13, the subject matter of Example 12 optionally includes wherein the integrated circuit is incorporated into central processing unit.

In Example 14, the subject matter of any one or more of Examples 12-13 optionally include wherein the current patch content comprises an encrypted patch.

In Example 15, the subject matter of any one or more of Examples 12-14 optionally include wherein the on-die non-volatile memory device comprises a flash memory device.

In Example 16, the subject matter of any one or more of Examples 12-15 optionally include wherein the on-die non-volatile memory device comprises an erasable programmable read-only memory device.

In Example 17, the subject matter of any one or more of Examples 12-16 optionally include wherein the hash of the previous patch content was obtained during a previous patch load operation of the current patch content.

In Example 18, the subject matter of any one or more of Examples 12-17 optionally include wherein applying the current patch content comprises: obtaining plaintext patch content of the current patch content from the on-die non-volatile memory; and using the plaintext patch content to apply the patch.

In Example 19, the subject matter of Example 18 optionally includes validating the plaintext patch content before using it to the apply the patch.

In Example 20, the subject matter of Example 19 optionally includes wherein validating the plaintext patch content comprises: obtaining a hash of plaintext of the current patch content; and comparing the hash of the plaintext of the current patch content with a hash of a plaintext patch that was previously applied.

In Example 21, the subject matter of Example 20 optionally includes wherein the hash of the plaintext patch that was previously applied is stored in the on-die non-volatile memory.

In Example 22, the subject matter of any one or more of Examples 12-21 optionally include wherein applying the current patch content comprises: decrypting the current patch content to obtain a plaintext patch content; and using the plaintext patch content to apply the patch.

Example 23 is at least one machine-readable medium including instructions, which when executed by a machine, cause the machine to perform operations of any of the methods of Examples 12-22.

Example 24 is an apparatus comprising means for performing any of the methods of Examples 12-22.

Example 25 is an apparatus for secure microcode updates, the apparatus comprising: means for determining, at an integrated circuit, a hash of a current patch content; means for obtaining, from an on-die non-volatile memory device, a copy of a previously-determined hash of a previous patch content; means for validating the current patch content by comparing the hash of the current patch content with the hash of the previous patch content; and means for applying the current patch content when the current patch content is validated.

In Example 26, the subject matter of Example 25 optionally includes wherein the integrated circuit is incorporated into central processing unit.

In Example 27, the subject matter of any one or more of Examples 25-26 optionally include wherein the current patch content comprises an encrypted patch.

In Example 28, the subject matter of any one or more of Examples 25-27 optionally include wherein the on-die non-volatile memory device comprises a flash memory device.

In Example 29, the subject matter of any one or more of Examples 25-28 optionally include wherein the on-die non-volatile memory device comprises an erasable programmable read-only memory device.

In Example 30, the subject matter of any one or more of Examples 25-29 optionally include wherein the hash of the previous patch content was obtained during a previous patch load operation of the current patch content.

In Example 31, the subject matter of any one or more of Examples 25-30 optionally include wherein the means for applying the current patch content comprise: means for obtaining plaintext patch content of the current patch content from the on-die non-volatile memory; and means for using the plaintext patch content to apply the patch.

In Example 32, the subject matter of Example 31 optionally includes means for validating the plaintext patch content before using it to the apply the patch.

In Example 33, the subject matter of Example 32 optionally includes wherein the means for validating the plaintext patch content comprise: means for obtaining a hash of plaintext of the current patch content; and means for comparing the hash of the plaintext of the current patch content with a hash of a plaintext patch that was previously applied.

In Example 34, the subject matter of Example 33 optionally includes wherein the hash of the plaintext patch that was previously applied is stored in the on-die non-volatile memory.

In Example 35, the subject matter of any one or more of Examples 25-34 optionally include wherein the means for applying the current patch content comprise: means for decrypting the current patch content to obtain a plaintext patch content; and means for using the plaintext patch content to apply the patch.

Example 36 is at least one machine-readable medium including instructions for secure microcode updates, which when executed by a machine, cause the machine to perform the operations comprising: determining, at an integrated circuit, a hash of a current patch content; obtaining, from an on-die non-volatile memory device, a copy of a previously-determined hash of a previous patch content; validating the current patch content by comparing the hash of the current patch content with the hash of the previous patch content; and applying the current patch content when the current patch content is validated.

In Example 37, the subject matter of Example 36 optionally includes wherein the integrated circuit is incorporated into central processing unit.

In Example 38, the subject matter of any one or more of Examples 36-37 optionally include wherein the current patch content comprises an encrypted patch.

In Example 39, the subject matter of any one or more of Examples 36-38 optionally include wherein the on-die non-volatile memory device comprises a flash memory device.

In Example 40, the subject matter of any one or more of Examples 36-39 optionally include wherein the on-die non-volatile memory device comprises an erasable programmable read-only memory device.

In Example 41, the subject matter of any one or more of Examples 36-40 optionally include wherein the hash of the previous patch content was obtained during a previous patch load operation of the current patch content.

In Example 42, the subject matter of any one or more of Examples 36-41 optionally include wherein applying the current patch content comprises: obtaining plaintext patch content of the current patch content from the on-die non-volatile memory; and using the plaintext patch content to apply the patch.

In Example 43, the subject matter of Example 42 optionally includes validating the plaintext patch content before using it to the apply the patch.

In Example 44, the subject matter of Example 43 optionally includes wherein validating the plaintext patch content comprises: obtaining a hash of plaintext of the current patch content; and comparing the hash of the plaintext of the current patch content with a hash of a plaintext patch that was previously applied.

In Example 45, the subject matter of Example 44 optionally includes wherein the hash of the plaintext patch that was previously applied is stored in the on-die non-volatile memory.

In Example 46, the subject matter of any one or more of Examples 36-45 optionally include wherein applying the current patch content comprises: decrypting the current patch content to obtain a plaintext patch content; and using the plaintext patch content to apply the patch.

Example 47 is at least one machine-readable medium including instructions, which when executed by a machine, cause the machine to perform operations of any of the operations of Examples 1-46.

Example 48 is an apparatus comprising means for performing any of the operations of Examples 1-46.

Example 49 is a system to perform the operations of any of the Examples 1-46.

Example 50 is a method to perform the operations of any of the Examples 1-46.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. An integrated circuit for secure microcode updates, the integrated circuit comprising:
a hash circuit to determine a hash of a current patch content;
a memory controller to obtain, from an on-die non-volatile memory device, a copy of a previously-determined hash of a previous patch content;
a patch loader to:
validate the current patch content by comparing the hash of the current patch content with the hash of the previous patch content; and
apply the current patch content when the current patch content is validated.

2. The integrated circuit of claim 1, wherein the integrated circuit is incorporated into a central processing unit.

3. The integrated circuit of claim 1, wherein the current patch content comprises an encrypted patch.

4. The integrated circuit of claim 1, wherein the on-die non-volatile memory device comprises a flash memory device.

5. The integrated circuit of claim 1, wherein the on-die non-volatile memory device comprises an erasable programmable read-only memory device.

6. The integrated circuit of claim 1, wherein the hash of the previous patch content was obtained during a previous patch load operation of the current patch content.

7. The integrated circuit of claim 1, wherein to apply the current patch content, the patch loader is to:
obtain plaintext patch content of the current patch content from the on-die non-volatile memory; and
use the plaintext patch content to apply the patch.

8. The integrated circuit of claim 7, wherein the patch loader is to:
validate the plaintext patch content before using it to the apply the patch.

9. The integrated circuit of claim 8, wherein to validate the plaintext patch content, the patch loader is to:
obtain a hash of plaintext of the current patch content; and
compare the hash of the plaintext of the current patch content with a hash of a plaintext patch that was previously applied.

10. The integrated circuit of claim 9, wherein the hash of the plaintext patch that was previously applied is stored in the on-die non-volatile memory.

11. The integrated circuit of claim 1, wherein to apply the current patch content, the patch loader is to:
decrypt the current patch content to obtain a plaintext patch content; and
use the plaintext patch content to apply the patch.

12. A method of secure microcode updates, the method comprising:
determining, at an integrated circuit, a hash of a current patch content;
obtaining, from an on-die non-volatile memory device, a copy of a previously-determined hash of a previous patch content;
validating the current patch content by comparing the hash of the current patch content with the hash of the previous patch content; and
applying the current patch content when the current patch content is validated.

13. The method of claim 12, wherein the integrated circuit is incorporated into central processing unit.

14. The method of claim 12, wherein the current patch content comprises an encrypted patch.

15. The method of claim 12, wherein the on-die non-volatile memory device comprises a flash memory device.

16. The method of claim 12, wherein the on-die non-volatile memory device comprises an erasable programmable read-only memory device.

17. The method of claim 12, wherein the hash of the previous patch content was obtained during a previous patch load operation of the current patch content.

18. The method of claim 12, wherein applying the current patch content comprises:
obtaining plaintext patch content of the current patch content from the on-die non-volatile memory; and
using the plaintext patch content to apply the patch.

19. The method of claim 18, further comprising:
validating the plaintext patch content before using it to the apply the patch.

20. The method of claim 19, wherein validating the plaintext patch content comprises:
obtaining a hash of plaintext of the current patch content; and
comparing the hash of the plaintext of the current patch content with a hash of a plaintext patch that was previously applied.

21. The method of claim 20, wherein the hash of the plaintext patch that was previously applied is stored in the on-die non-volatile memory.

22. The method of claim 12, wherein applying the current patch content comprises:
decrypting the current patch content to obtain a plaintext patch content; and
using the plaintext patch content to apply the patch.

23. At least one non-transitory machine-readable medium including instructions for secure microcode updates, which when executed by a machine, cause the machine to perform the operations comprising:
determining, at an integrated circuit, a hash of a current patch content;
obtaining, from an on-die non-volatile memory device, a copy of a previously-determined hash of a previous patch content;
validating the current patch content by comparing the hash of the current patch content with the hash of the previous patch content; and
applying the current patch content when the current patch content is validated.

24. The at least one machine-readable medium of claim 23, wherein the hash of the previous patch content was obtained during a previous patch load operation of the current patch content.

25. The at least one machine-readable medium of claim 23, wherein applying the current patch content comprises:
obtaining plaintext patch content of the current patch content from the on-die non-volatile memory; and
using the plaintext patch content to apply the patch.
